(19) United States
(12) Patent Application Publication
(10) Pub. No.: US 2009/0010820 A1
(43) Pub. Date: Jan. 8, 2009

(54) Micro-Fluidic System

(76) Inventors: Udo Fehm, Furth (DE); Astrid Lohf, Erlangen (DE); Hermann Ruhl, Markt Erlbach (DE); Reinhold Schneeberger, Seukendorf (DE); Johann Sippl, Nurnberg (DE); Waldemar Wenzel, Furth (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/579,710

(22) PCT Filed: May 6, 2005
(86) PCT No.: PCT/EP2005/04951

§ 371 Date: Sep. 8, 2008

(30) Foreign Application Priority Data
May 6, 2004 (DE) 10 2004 022 423.4

(51) Int. Cl. B01J 19/00

(52) U.S. Cl. 422/189

(57) ABSTRACT

In one aspect, a micro-fluidic system consisting of modules that are arranged side by side in a row, each module containing a micro-fluidic unit and an associated electric control unit is provided. The rear faces of the modules lie against a common vertical rear wall unit and are held against the unit. In the modules, the respective control unit is located in the vicinity of the rear face and the micro-fluidic unit is situated in a region that is remote from the rear face. The control units can be connected to an electric line bus that runs through the rear wall unit via electric connectors that are located on the rear faces of the modules and on the rear wall unit and the micro-fluidic units of two respective neighboring modules are interconnected to allow the passage of fluid via a connecting part that contains connection channels and that spans the relevant modules.

The invention relates to a micro-fluidic system, as is similarly known from WO 01/36085 A1, WO 01/73823 A2 and from WO 02/065221 A2. The known micro-fluidic systems consist of a number of modules, each containing a micro-fluidic unit and an associated electrical control unit, and are able to be mounted on their rear sides in a row next to one another on a mounting rail. The control units of the different modules are connected to each other via an electric line bus and the micro-fluidic units are connected to each other via a fluid bus. As WO 02/065221 A2 shows, the fluid bus can be formed by the micro-fluidic units of neighboring modules being connected to each other by connecting parts containing connection channels and spanning the relevant modules.

Depending on requirements the micro-fluidic units must be cooled or heated, in order for example in the case of a chemical reaction of fluids in a micro reactor, to set the reaction temperature or to conduct away heat released during the reaction. The electrical control units are on the one hand heat-sensitive and on the other hand generate waste heat themselves.

The inventive micro-fluidic system now consists of a number of modules arranged side by side in a row, each containing a micro-fluidic unit and an associated electric control unit,
with the rear faces of the modules lying against a common vertical rear wall and being held against said wall,
with the relevant control unit being arranged in the modules in the area of the rear wall and the micro-fluidic units in an area away from the rear wall,
with the control units being able to be connected via electrical connection parts arranged on the rear wall unit to an electrical line bus running within the rear wall unit and
with the micro-fluidic units of two neighboring modules being connected fluidly to each other via a connecting part containing connection channels and spanning the modules concerned.

Since the electrical control units are arranged in the rear face area of the modules, the waste heat generated by the control units can effectively be removed via the rear wall unit used for mounting the modules. The proximity of the control units to the rear wall unit is utilized in this case to lay the electrical line bus connecting the control units, i.e. the data and power supply lines, in the rear wall unit, with the connection between the control units and the line bus being made by connecting parts. Since the line bus does not run in sections in the modules but is separated from these, the number of electrical connections needed and especially the electrical connectors lying in a row is minimized. The micro-fluidic units are decoupled from the electrical control units as far as heat is concerned by being arranged in an area away from the rear face, for example the front face or the top face of the modules, and are connected there by means of the connecting parts spanning the neighboring modules in each case. Arranging them in the area of the front face or top face of the modules means that the micro-fluidic units are also easily accessible and can, for example in the event of faults or wear, be easily exchanged. The micro-fluidic system can additionally contain modules without fluid units, such as energy or pressure supply modules for example, or modules without control units, such as fluid feed or waste containers for example, which are held in the same manner as the other modules on the rear wall unit.

To reduce the circuit complexity the control units in the modules are only embodied to perform module-specific functions, with supplementary cross-module functions being performed by an additional control unit integrated into the rear wall or held on this wall, in the form of an additional module for example.

Preferably the micro-fluidic units are arranged in the area of the upper face of the relevant modules, so that further micro-fluidic or macro-fluidic units, such as pumps, valves etc., are arranged below the micro-fluidic unit concerned in the module and can have a fluid connection to the micro-fluidic unit. It is however also possible, if the micro-fluidic units are arranged on the front face or the top face of the modules, to mount the further micro- or macro-fluidic units externally on the modules, and in doing so connect them to the micro-fluidic units.

The micro-fluidic units in the different modules preferably lie with a face containing fluid connections in each case in a common plane, with the connecting parts in this plane lying against the micro-fluidic parts in each case such that two neighboring micro-fluidic parts are respectively partly overlapped and that the connecting part connects the fluid connections of the neighboring micro-fluidic parts lying in the overlapping area to each other via its connection channels. The fluid connection is thus made directly via the fluid connections in the micro-fluidic parts and the connection channels in the neighboring connecting parts, with only sealing means, such as sealing rings for example, being required in the fluid connection area in order to seal the system externally.

Hose lines between the micro-fluidic parts are avoided in this way, so that the fluids are only carried in the channels of the micro-fluidic parts and the connecting parts. Outside the overlapping areas the micro-fluidic units can have further fluid connections, for connecting the micro-fluidic or macro-fluidic units already mentioned for example.

The micro-fluidic units are preferably embodied as planar micro-fluidic parts, for example as an individual plate or in the form of a compound plate made of steel, glass, silicon or another suitable material. Within the plate or the plates fluid channels run essentially in parallel to the two large faces of the plate and to this end are connected vertically to the fluid connections and where necessary to further fluid connections in one of the two or in both exterior main faces of the plate. The compound plate can also be constructed in such a way that the actual micro-fluidic unit or also a number or micro-fluidic units above or below one another are accommodated on a fluid distributor plate which also contains the fluid connections to the neighboring micro-fluidic units. The connecting parts are preferably also embodied as plates and from the same material as the planar micro-fluidic parts, so that the formation of electrical local elements is prevented.

The connecting parts can be held directly against the modules arranged next to one another, in which case they are placed with their sides containing the fluid connections facing outwards in a common plane. The micro-fluidic units are then installed from outside against the connecting parts so that they lie against these parts under pressure. This is especially of advantage if the micro-fluidic units are breakable and only bear an evenly-distributed pressure load or if the micro-fluidic units have different heights in the different modules; the connecting parts then define with their outer faces a reference plane for the micro-fluidic units lying against them.

If the pressure applied to the micro-fluidic units, such as for planar parts made of steel or exact planar glass parts with low manufacturing tolerances, is not critical, the micro-fluidic units can be held directly on the modules, with the connecting parts then being able to be mounted from outside against the micro-fluidic units. The advantage of this is that the micro-fluidic units can be built into the modules before these are attached to the rear wall unit and the connecting parts are installed between neighboring modules in each case. If one module in the system is to be replaced, the micro-fluidic unit thus does not first have to be removed from the module concerned.

The modules preferably feature actuatable locking parts, for example cover parts, which in the locking state or in the closed state press the externally-mountable micro-fluidic units or connecting parts against the micro-fluidic units or connecting parts held directly on the modules. The pressure can be exerted directly in such cases or preferably via elastic pressure elements such as spring arms, pneumatically actuatable presses, or via fluid-filled or gas-filled cushions, which is especially also of advantage if, for manufacturing reasons, the pressure part is not aligned in a precisely planar manner, so that an even application of pressure by means of screw connections or other pressure elements cannot be implemented.

As well as the electrical line bus, the rear wall unit on which the modules are installed preferably contains at least one fluid line carrying at least one fluid, such as a cooling or heating fluid for tempering the micro-fluidic units in the modules, compressed air to activate pneumatic actuators in the modules, a cleaning fluid for flushing out the fluid channels in the micro-fluidic units or a flushing gas for purging inflammable gas mixtures from the modules. The modules is this case are connected on their rear faces via corresponding fluidic connecting parts to the at least one pressure fluid line in the rear wall unit.

For improved removal of the heat generated by the electrical control units in the modules the rear wall unit can advantageously feature in its area opposite the control units in the modules means for forced cooling, such as for example a cooling channel through which a coolant flows, a fan or Peltier elements.

The heat transfer from the electrical control units into the modules on the rear wall unit can be improved by the control units being mounted in the modules on a heat sink in each case, which lies with one heat transfer surface, if necessary with an intermediate layer of heat dissipation rubber or similar, flat against the rear wall unit surface.

Use of the inventive micro-fluidic system in explosion-hazard areas is advantageously enabled by the rear faces of the modules each having at least one recess which, together with the rear wall unit, forms a cavity sealed from the external environment in which the electrical connectors are accommodated. In this case the electrical control unit and where necessary the fluidic connector part can additionally be arranged within the relevant cavity. Furthermore a fluid line for a flushing fluid can be provided in the rear wall unit, with branches leading into the cavity from the fluid line, so that this flushing fluid flows through this cavity. The flushing fluid prevents the entry of air (oxygen) from outside into the cavities or thins out and removes and inflammable gas mixtures present in the cavities. In addition the flushing fluid causes a direct cooling down of the connectors and the electrical control units.

The individual modules can be held onto the rear wall unit in different ways. Preferably they are hung onto the rear wall unit, to which end the modules feature in their upper area means for attaching them to a suspension device, e.g. a mounting rail, in the upper area of the rear wall unit. This allows even heavy modules to be simply and securely attached to the rear wall unit. For fixing the modules these preferably feature means in the lower area of their rear faces, such as screw or snap-on connections for example, or other locking devices, to press the modules with their rear faces against the rear wall unit and thus improve the heat transfer from the control units in the modules into the rear wall unit or the sealing of the cavities accommodating the electrical connecting parts.

To increase the modularity of the inventive micro-fluidic systems and to be able to create subsystems and connect them to each other, the rear wall unit is advantageously able to be assembled from rear wall segments which feature connection terminals at the joining points for the line bus segments contained in the rear wall segments and if necessary fluid line segments. The rear wall segments each have a number of predetermined mounting locations for the modules and allow rear wall units of any length to be formed.

As already mentioned, additional equipment, especially macro-fluidic units such as pumps, valves etc. can be arranged within the modules. Where there is not enough space for these within the individual modules or where they do not perform module-specific functions, but higher-level functions, such as with higher-ranking units for process monitoring or for example pressure generators for auxiliary fluids (e.g. compressed air), there can be provision for the rear wall unit to feature on its side facing away from the modules mounting locations with connections for mounting and connection of these additional devices.

For further explanation of the invention reference is made below to the Figures of the drawing; The individual Figures show:

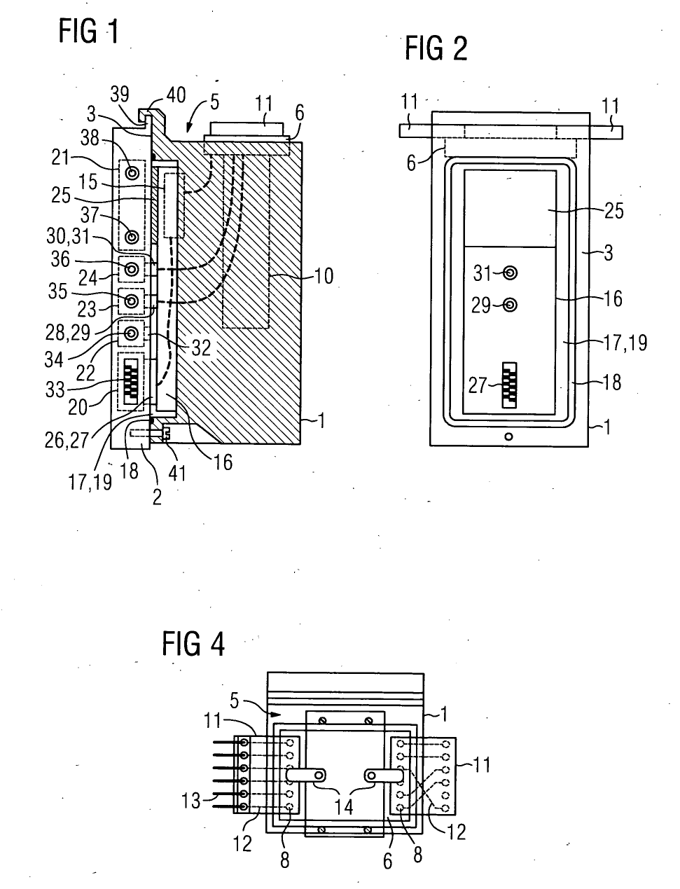

FIG. 1 a first exemplary embodiment for a module held on a rear wall unit, viewed from the side,

FIG. 2 a rear view of the module,

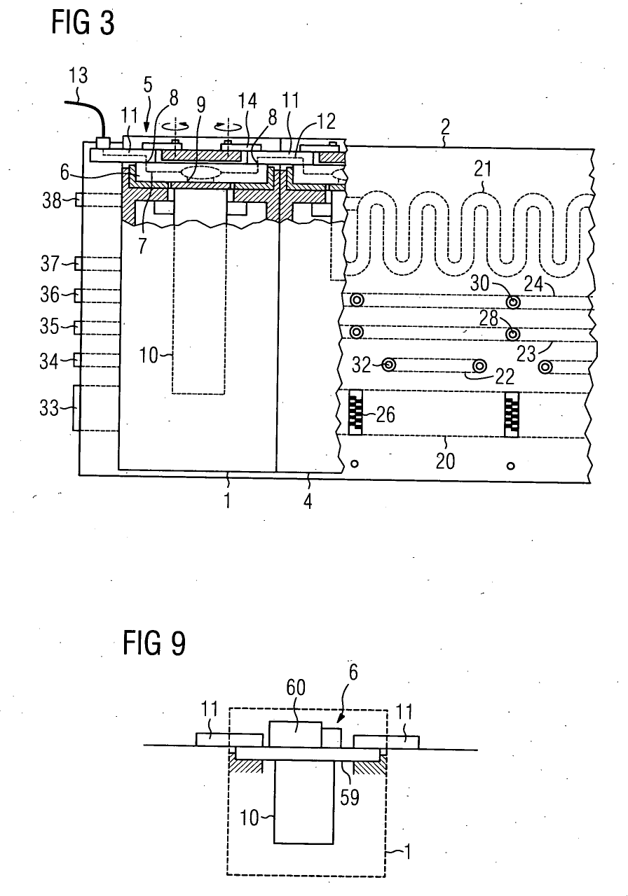

FIG. 3 a front view of the module on the rear wall unit together with a further neighboring module,

FIG. 4 the upper face of the module,

FIG. 5 a further exemplary embodiment for the module,

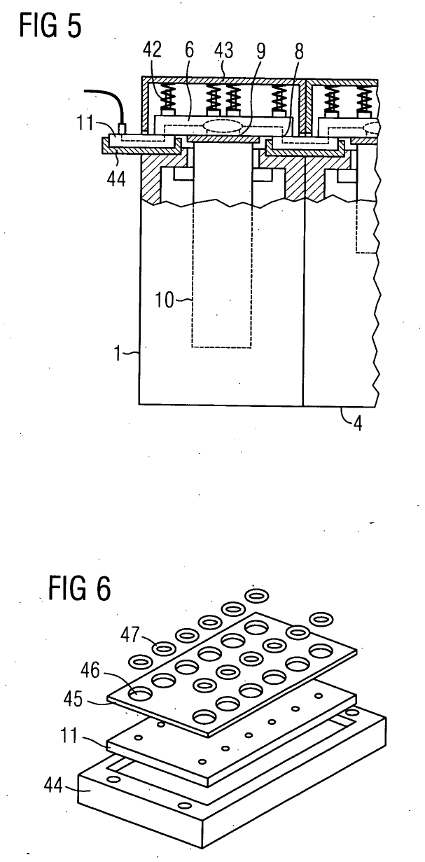

FIG. 6 an example for installing the connecting parts for the exemplary embodiment according to FIG. 5,

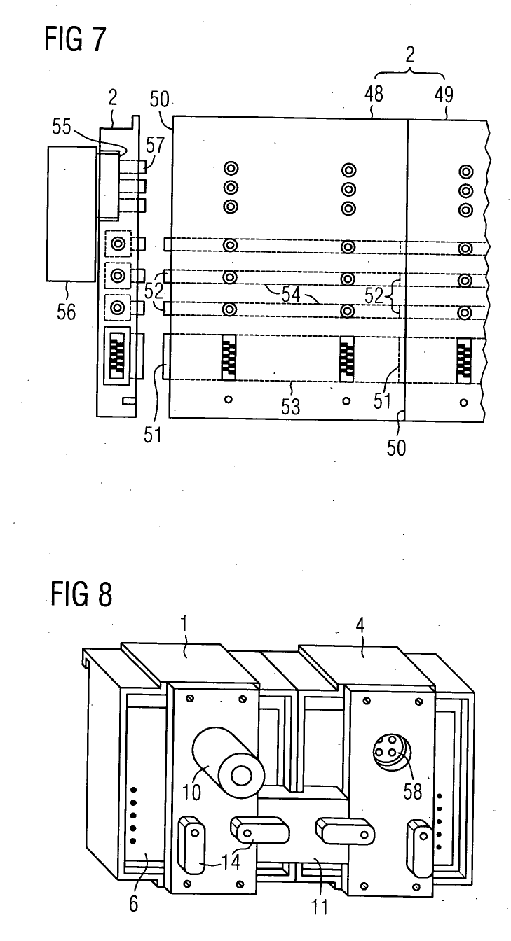

FIG. 7 an alternative exemplary embodiment for the rear wall unit,

FIG. 8 an example of installing the micro-fluidic units and connecting parts on the front face of the module and

FIG. 9 another example of the module.

FIG. 1 shows a side view of a module 1 which is held on a rear wall unit 2 and of which the rear face 3 lays against the latter. FIG. 2 shows a rear view and FIG. 3 a front view of the module 1, which, together with further modules 4 in a row next to one another, is held on the rear wall unit 2. The upper face 5 of the module 1 is shown in FIG. 4.

The module 1 contains a micro-fluidic unit 6, here in the form of a planar micro-fluidic part which is arranged and held in the area of the upper face 5 of the module 1 in parallel to this module. The micro-fluidic part 6 contains within it fluid channels 7, which, depending on the function of the module 1, typically form a reactor, a mixer or a delay stage for fluids or a number of such functional units and run essentially in parallel to the two large main faces of the planar micro-fluidic part 6. Those fluid channels 7 which are provided for connection to fluid channels in the micro-fluidic parts of neighboring modules, here for example the module 4, open out in fluid connections 8, which are contained on the upwards-facing main face of the micro-fluidic part 6 in areas close to the neighboring modules. Further fluid connections 9 on the downwards-facing main face of the micro-fluidic part 6 are used to connect further micro-fluidic or macro-fluidic units, here for example a pump 10. These further micro- or macro-fluidic units 10 are accommodated within the modules 1 in an area under the micro-fluidic part 6.

The micro-fluidic parts 6 of the neighboring modules 1 and 4 in each case have fluid connections to each other via connecting parts 11 with connection channels 12 contained within them. To this end the connecting parts 11 can be installed from outside against the micro-fluidic parts 6, in which case they span the micro-fluidic parts 6 of the immediately neighboring modules 1 and 4 in each case and via their connection channels 12 connect the fluid connections 8 of the adjacent micro-fluidic parts 6 to each other. For modules 1 which, as end modules in the row, have only one neighboring module 4, the connecting part 11 mounted on the face with the missing neighboring module is used to connect external fluid lines 13 for supplying fluids to or removing them from the row of modules. On the upper face 5 the modules 1, 4 are actuatable locking parts 14, with which the connecting parts 11 are pressed against the micro-fluidic parts 6.

As FIG. 1 shows, the module 1 contains an electrical control unit 15, which controls functions, such as for example valve settings or analysis processes, in the micro-fluidic unit 6 and/or the additional fluidic units 10, and records measured values, such as temperature, pressure, throughflow or analysis results, of the units 6 and/or 10 for example. The control unit 15 is arranged in the module 1 on the module's rear side 3 and is thus thermally decoupled from the micro-fluidic unit 6. In the exemplary embodiment shown the control unit 15 is mounted on a heat sink 16 which is arranged in the area of the rear face 13 of the module 1 within a recess 17, with the control unit 15 being able to be positioned within the recess 17. The recess 17 is surrounded by a seal 18 and with the rear wall unit 2, on which the module 1 is held, forms a closed sealed cavity 19.

The rear wall unit 2 contains an electrical line bus 20 with data and power supply lines, forced cooling 21, in the form of a coolant circuit, as well as a number of fluid lines 22, 23, 24 for carrying auxiliary fluids, such as cooling fluids for the micro-fluidic units 6, compressed air for controlling pneumatic units 10 or flushing gas for flushing out the cavity 19. The forced cooling unit 21 is arranged so that it is directly opposite the electrical control unit 15 in the module 1, so that the waste heat of the electrical control unit 15 is introduced via the heat sink 16 and where necessary a rubber heat conductor 25 directly into the rear wall unit 2 with the forced cooling unit 21 present there. The electrical connection between the control unit 15 and the electrical line bus 20 is made through electrical connecting parts 26 and 27 arranged on the rear wall unit 2 and the rear face 3 of the module 1. Likewise the fluidic connection between the fluidic units 6 and 10 and the fluid lines 23 and 24 is made by fluidic connecting parts 28, 29 or 30, 31. The fluid line 22 supplies the cavity 19 with a flushing gas via a branch 32, so that no inflammable gas mixtures can penetrate into the cavity 19 from outside. The electrical line bus 20, the fluid lines 22, 23, 24 and the coolant circulation 21 have additional connections 33 to 38 on the vertical narrow face of the rear wall unit 2.

The rear wall unit 2 has a mounting rail 39 in its upper area, on which the module 1 is suspended by means of a suspension device 40. A screw connection 41 is provided in the lower area to fix the module 1 and to press its rear face 3 with the heat sink 16 and the seal 18 surrounding the cavity 19 against the rear wall unit 2.

The exemplary embodiment shown in FIG. 5 differs from the previous embodiment in that the micro-fluidic part 6 is not held directly on the module, but instead its connecting parts 11, with the connecting parts 11 forming with their outer, i.e. upwards-facing main faces, a reference plane for the micro-fluidic parts 6, which are pressed from outside against the connecting parts 11. Both the fluid connections 8 and 9 used for connection to the neighboring micro-fluidic units and also those used for connection to the additional fluidic unit 10 lie on a single, main face of the micro-fluidic part, namely the downwards-facing main face of the micro-fluidic part 6. On the upper main face facing in the opposite direction the micro-fluidic part 6 is pressed via pressure elements, here spring arms which are arranged in an openable and closable cover part 43 of the module 1, elastically at points lying opposite the fluid connections 8 or 9 against the connecting parts 11.

FIG. 6 shows an example of mounting the connecting parts in a holder 44 which can be mounted directly on the module 1, with a template part 45 with openings opposite the fluid connections 8 in the micro-fluidic part 6 lying on the upper face facing the micro-fluidic parts 6 to accommodate sealing rings 47.

FIG. 7 shows another exemplary embodiment of the rear wall unit 2, which is made up of rear wall segments 48, 49. The rear wall segments 48, 49 have connectors 51, 52 at the adjoining points 50 for the line bus segments 53 and fluid line segments 54 contained in the rear wall segments 48, 49. In addition the rear wall unit 2 features mounting locations 55 on its side facing away from the modules for accommodating additional devices 56, such as pressure generators for auxiliary fluids, which can be connected to the lines of the rear wall unit 2 or, as shown here, are able to be connected via connections 57 in the rear wall unit 2 to the modules held on it.

FIG. 8 shows an exemplary embodiment with two modules 1 and 4, in which the micro-fluidic parts 6 and the connecting parts 11 connecting them are arranged on the front face of the modules 1 and 4. In this Figure, in the same way as shown in the exemplary embodiment according to FIG. 4, the connecting parts 11 are pressed from outside against the micro-fluidic parts 6 with the aid of locking parts 14. Further additional fluidic devices 10 can be mounted externally on the modules 1 and 4, in which case they are connected fluidically via fluid passages in a sealing part 58 to the micro-fluidic part 6.

Finally FIG. 9 shows a schematic diagram of an exemplary embodiment, in which the micro-fluidic unit 6 is held directly in the module 1 and the connecting parts 11 can be mounted from outside against the micro-fluidic unit 11. The micro-fluidic unit 6 consists of a fluid distributor plate 59, on the upper face of which there are connecting parts 11 held under pressure and on which a number of micro-fluidic subunits 60 are accommodated next to one another. Further additional fluidic units 10 can be mounted on the underside of the fluid distributor plate 59.

1.-19. (canceled)

20. A micro-fluidic system, comprising:
a common vertical rear wall unit;
an electrical bus within the rear wall unit;
a plurality of modules arranged next to one another in a row, each module comprising:
a rear face,
a micro-fluidic unit arranged in an area away from the rear face,
an electrical control unit arranged in an area of the rear face, and
an electrical connection part arranged on the rear face, the electrical connection part effective to connect the control unit to the electrical bus; and
a connecting part having a connection channel,
wherein each module having the respective rear face arranged against the common vertical rear wall unit and being held on the latter, and
wherein the micro-fluidic units of two neighboring modules in each case having a fluid connection to each other via the connecting part that spans the respective neighboring modules.

21. The micro-fluidic system as claimed in claim 20,
wherein the control units are embodied for performing module-specific functions, and
wherein an additional control unit is integrated into the rear wall unit or held against said wall unit.

22. The micro-fluidic system as claimed in claim 20,
wherein the micro-fluidic unit is arranged in an area of an upper face of the respective module,
wherein a further unit is arranged below the micro-fluidic unit in the respective module, the further unit having a fluid connection to the respective module, and
wherein the further unit is a micro-fluidic or a macro-fluidic unit.

23. The micro-fluidic system as claimed in claim 20,
wherein the two neighboring modules include a first module and a second module,
wherein the connecting part includes a plurality of fluid connection parts in a common plane and includes a plurality of connection channels, each fluid connection part connected to a connection channel, and
wherein the connecting part operatively connected to the micro fluidic unit of the first module and operatively connected to the micro fluidic unit of the second module providing a fluid connection between the neighboring modules via the connection channels.

24. The micro-fluidic system as claimed in claim 23, wherein the micro-fluidic unit is embodied as planar micro-fluidic parts.

25. The micro-fluidic system as claimed in claim 23, wherein the connecting part is held on the neighboring modules and that the micro-fluidic units are mounted from outside onto the connecting part.

26. The micro-fluidic system as claimed in claim 23, wherein in that the micro-fluidic units are held onto the neighboring modules and that the connecting part is mounted from outside onto the micro-fluidic unit.

27. The micro-fluidic system as claimed in claim 23,
wherein the neighboring modules each include an locking part,
wherein the locking part in the locking state presses the micro-fluidic units mounted from outside against the connecting part or
wherein the locking part in the locking state presses the connecting part mounted from outside against the micro-fluidic unit.

28. The micro-fluidic system as claimed in claim 27, wherein the locking part is embodied as a cover part.

29. The micro-fluidic system as claimed in claim 20,
wherein the rear wall unit further includes:
a pressure fluid line carrying an auxiliary fluid, and
a fluid connector part,
wherein the rear face includes a fluid connector part, and
wherein the module is connected to the pressure fluid line via the connectors

30. The micro-fluidic system as claimed in claim 20, wherein the rear wall unit includes in an area opposite the control units in the modules a forced cooling unit.

31. The micro-fluidic system as claimed in claim 20, wherein the electrical control unit is mounted on a heat sink such that a heat transfer face of the heat sink is in communication with the rear wall unit.

32. The micro-fluidic system as claimed in claim 20, wherein the rear face includes a recess forming with the real wall unit an externally-sealed cavity in which the electrical connecting part is accommodated.

33. The micro-fluidic system as claimed in claim 32, wherein the electrical control unit is arranged in the cavity.

34. The micro-fluidic system as claimed in claim 32, wherein a pressure fluid line effective for a flushing fluid is provided in the rear wall unit with branches leading into the cavity from the fluid line, so that a flushing fluid flows through the line into the cavity.

35. The micro-fluidic system as claimed in claim 20, wherein each module includes a suspension device in the area of the rear face, the suspension device for suspending the module on a mounting rail of the rear wall unit.

36. The micro-fluidic system as claimed in claim 20, wherein a screw connection is included in a lower area of the rear face for pressing the rear face against the rear wall unit.

37. The micro-fluidic system as claimed in claim 20, wherein rear wall unit is formed from rear wall segments which, at the points at which they join, features connections for the line bus element.

38. The micro-fluidic system as claimed in claim 20, wherein the rear wall unit on its side facing away from the module with mounting locations with terminals for mounting and for connecting additional devices.
